(19) United States
(12) Patent Application Publication
(10) Pub. No.: US 2023/0323139 A1
(43) Pub. Date: Oct. 12, 2023

(54) ZIRCONIA MONOMERIC DISPERSION LIQUID AND PREPARATION METHOD THEREFOR, OPTICAL FILM AND DISPLAY SCREEN

(71) Applicant: SHANDONG SINOCERA FUNCTIONAL MATERIAL CO., LTD., Dongying (CN)

(72) Inventors: Xibin SONG, Dongying (CN); Haiyang MA, Dongying (CN); Yuxing LYU, Dongying (CN); Liaodong AI, Dongying (CN); Hongliang XI, Dongying (CN); Yan ZHANG, Dongying (CN)

(21) Appl. No.: 18/332,941

(22) Filed: Jun. 12, 2023

Related U.S. Application Data
(63) Continuation-in-part of application No. PCT/CN2022/119288, filed on Sep. 16, 2022.

(30) Foreign Application Priority Data
Mar. 18, 2022 (CN) 202210271565.8

(51) Int. Cl. C09D 7/61; C09D 133/14; C09D 7/40; C09D 7/45; C09D 7/65; C09D 7/63; C09D 7/80

(52) U.S. Cl. CPC C09D 7/61; C09D 133/14; C09D 7/67; C09D 7/45; C09D 7/65; C09D 7/63; C09D 7/80

(57) ABSTRACT

The present disclosure provides a zirconia monomeric dispersion liquid, a preparation method thereof, an optical film and a display screen, which relates to the technical field of zirconia. The zirconia monomeric dispersion liquid is mainly made of raw materials such as nano-zirconia, monomeric resin, stabilizer and refractive index modifier. The present disclosure also provides a method for preparing the above-mentioned zirconia monomeric dispersion liquid.

### CROSS-REFERENCE TO RELATED APPLICATION

The present disclosure is a continuation-in-part of International Application No. PCT/CN2022/119288, filed Sep. 16, 2022 and also claims priority to CN 202210271565.8, filed Mar. 18, 2022, the entire contents of which are incorporated herein by reference.

### TECHNICAL FIELD

The present disclosure relates to the technical field of zirconia (zirconium oxide), in particular to a zirconia monomeric dispersion liquid and a preparation method therefor, an optical film and a display screen.

### BACKGROUND ART

In recent years, a zirconia particle dispersion is combined with a transparent resin or a thin film to obtain a monomeric zirconia dispersion liquid, which is well applied in the optical field. For example, optical films such as brightness enhancement films prepared with zirconia monomeric dispersion liquid can be used on LCD displays to increase the brightness and clarity of the screen.

In the above application, when the primary particle size of zirconia and the secondary aggregating particle size of zirconia in the monomeric resin are close to the wavelength of visible light (380-800 nm), due to the influence of scattering by zirconia particles, white turbidity occurs in the monomeric resin or the membrane system, such that the required transparency cannot be obtained. Therefore, to develop a high-transparency zirconia dispersion liquid that zirconia particles are dispersed in a resin in the form of microparticle is urgent.

Although some monomeric dispersion liquid has been successfully prepared now, most of them have problem of poor transmittance, which affects the effect when being applied to the downstream display field. For example, patent CN 106268394 B discloses a method for preparing zirconia particles or its dispersion liquid, when the zirconia contained in its aqueous dispersion liquid takes up more than 20% by weight, the transmittance at a wavelength of 400 nm is more than 35%. The transmittance at 800 nm is above 95%, and the viscosity at 25° C. is less than 20 mPa·s. However, this patent does not involve the content of the transmittance of the zirconia monomeric dispersion liquid. The zirconia monomeric dispersion liquid is an organic-inorganic composite system, and the components interact with each other and the influencing factors are complicated, especially the refractive index of each component in the system. Balancing the transmittance of the system and the stability of zirconia particles in the system is difficult. Blindly pursuing a high index in one aspect will inevitably lead to a decrease in the index of another aspect. Therefore, it is of great significance to develop a monomeric dispersion liquid that has simple process, coordinated indices in the system and high transmittance and is suitable for practical applications.

In view of this, the present disclosure is proposed.

### SUMMARY

The object of the present disclosure includes providing a zirconia monomeric dispersion liquid and a preparation method therefor, so as to solve at least one technical problem existing in the prior art.

In order to achieve the above object, the technical solution of the present disclosure is as follows.

The present disclosure provides a zirconia monomeric dispersion liquid, comprising the following raw materials:
nano-zirconia, monomeric resin, stabilizer and refractive index modifier, wherein
the mass fraction of the nano-zirconia accounting for the zirconia monomeric dispersion liquid is 50%-75%;
the mass of the stabilizer is 1%-10% of the mass of the nano-zirconia;
the mass of the refractive index modifier is 1%-10% of the mass of the nano-zirconia; and
the monomeric resin includes any one of phenoxybenzyl acrylate, biphenylmethanol acrylate, benzyl acrylate or o-phenylphenoxyethyl acrylate, or a combination of at least two therefrom.

### DETAILED DESCRIPTION OF EMBODIMENTS

The following will clearly and completely describe the technical solutions in the embodiments of the present disclosure. Apparently, the described embodiments are only a part of the embodiments of the present disclosure, rather than all the embodiments. The detailed description of the embodiments and examples of the present disclosure is not intended to limit the scope of the claimed disclosure, but merely represents selected embodiments of the present disclosure. Based on the embodiments of the present disclosure, all other embodiments obtained by those skilled in the art without making inventive efforts belong to the scope of protection of the present application.

Those without indicating the specific conditions in the examples are carried out according to the conventional conditions or the conditions suggested by the manufacturer. The reagents or instruments used without indicating manufacturer are all conventional products that can be purchased from the market.

The present disclosure provides a zirconia monomeric dispersion liquid, including the following raw materials:
nano-zirconia, monomeric resin, a stabilizer and a refractive index modifier, wherein
the mass fraction of nano-zirconia accounting for the zirconia monomeric dispersion liquid is 50%-75%;
the mass of stabilizer is 1%-10% of the mass of nano-zirconia;
the mass of the refractive index modifier is 1%-10% of the mass of the nano-zirconia; and
the monomeric resin includes any one of phenoxybenzyl acrylate, biphenylmethanol acrylate, benzyl acrylate or o-phenylphenoxyethyl acrylate, or a combination of at least two therefrom.

In the present disclosure, the source of the nano-zirconia is not limited, which can be obtained commercially, and can also be self-prepared using conventional preparation methods in the art.

The type of monomeric resin has certain restriction, so as to make it has good dispersion ability for nano-zirconia, require no participation of intermediate phase, and also has a refractive index matching that of nano-zirconia.

Nano-zirconia is used as the inorganic dispersed particles in the zirconia monomeric dispersion liquid. On the one hand, due to its small particle size, the scattering effect of particles on light can be reduced, thereby improving the transmittance of the system. On the other hand, the refractive index of nano-zirconia also has a good matching degree with the refractive index of the specific type of monomeric resin disclosed herein, which can greatly reduce the degree of scattering of light by the system, thereby increasing the transmittance of the system.

The addition of the stabilizer can make the nano-zirconia not easy to agglomerate and have better stability, such that the system keeps a higher transmittance.

The refractive index modifier can make the matching degree of refractive index between nano-zirconia and monomeric resin higher, such that the whole system has higher transmittance.

There are certain restrictions on the amount of each raw material in the zirconia monomeric dispersion liquid.

The typical but non-limiting mass fraction of nano-zirconia is 50%, 52%, 54%, 56%, 58%, 60%, 62%, 64%, 65%, 66%, 68%, 70%, 72%, 74%, or 75%.

Since the monomeric resin is mainly for dispersing the nano-zirconia, its amount only needs to ensure that the mass fraction of nano-zirconia in the zirconia monomeric dispersion liquid reaches 50-75%.

The added amount of stabilizer and refractive index modifier is calculated by the mass of nano-zirconia.

The typical but non-limiting mass fraction of the stabilizer in the nano-zirconia is 1%, 2%, 3%, 4%, 5%, 6%, 7%, 8%, 9% or 10%. If the mass fraction of the stabilizer in nano-zirconia is too low (less than 1%), it is not able to stabilize the system and increase the transmittance of the system; and if the mass fraction of the stabilizer in nano-zirconia is too high (higher than 10%), it will affect the refractive index matching degree of each component of the whole system, resulting in failure to achieve the expected effect and increasing the cost.

The typical but non-limiting mass fraction of the refractive index modifier in nano-zirconia is 1%, 2%, 3%, 4%, 5%, 6%, 7%, 8%, 9% or 10%. If the mass fraction of the refractive index modifier in nano-zirconia is too low (less than 1%), it is not able to adjust the refractive index matching degree of the system; and if the mass fraction of the refractive index modifier in nano-zirconia is too high (higher than 10%), it is easy to fail the expected effect, and the cost increases.

The present disclosure provides a zirconia monomeric dispersion liquid, which is mainly made of raw materials such as nano-zirconia, monomeric resin, stabilizer, and refractive index modifier, wherein the nano-zirconia is used as inorganic dispersed particles, which can reduce the scattering effect of particles on light, thereby improving the transmittance of the system; the addition of stabilizers can improve the dispersion and uniformity of zirconia monomeric dispersion liquid; moreover, the addition of the refractive index modifier can make the refractive index of each raw material in the whole system more matched, thus improving the transmittance of the system. The zirconia monomeric dispersion liquid has higher stability and transmittance through the cooperation between the aforementioned raw materials.

In some embodiments of the present disclosure, the average particle size of the nano-zirconia is 1 to 20 nm. Typical but non-limiting particle size of nano-zirconia is, for example, 1 nm, 2 nm, 4 nm, 5 nm, 6 nm, 8 nm, 10 nm, 12 nm, 14 nm, 15 nm, 16 nm, 18 nm or 20 nm.

By limiting the average particle size of nano-zirconia, it is beneficial to improve the refractive index of the system.

In some embodiments of the present disclosure, the structure of the stabilizer is R—Xₙ, wherein R is an anchoring group that can achieve the anchoring effect with nano-zirconia, and X is a solvation group that can interact with monomeric resin.

R is any one selected from alkyl groups, sulfonic acid groups, phosphate groups, amide groups, carboxyl groups, hydroxyl groups, aromatic rings or substituted aromatic rings, or a combination of at least two therefrom.

X is any one selected from polyether chains, acrylate chains, polyester chains or alkyl chains, or a combination of at least two therefrom.

n is an integer of 1 to 3, such as 1, 2 or 3.

In some embodiments of the present disclosure, the stabilizer includes any one of polyoxyethylene octylphenol ether, polyoxyethylene alkyl ether, triethylhexyl phosphoric acid, stearamide or hydroxypropyl acrylate, or a combination of at least two therefrom.

By specifically restricting the type of R and X groups in the structure of the stabilizer and the type of the stabilizer, the stabilizer can better interact with the zirconia particles and the monomeric resin to improve the transmittance of the system.

In some embodiments, the structure of the refractive index modifier is A-Bₘ.

A is any one selected from substituted or unsubstituted acryloyloxy groups, methylene groups, alkoxy groups, carbon-carbon double bonds, silyl groups or alkyl groups, or a combination of at least two therefrom.

B is any one selected from hydroxyl groups, carbonyl groups, ester groups, siloxy groups, alkoxy groups, carboxyl groups, or substituted or unsubstituted aromatic rings, or a combination of at least two therefrom.

m is an integer of 1 to 3, such as 1, 2 or 3.

In some embodiments, the refractive index modifier includes any one of glycol ether, 4-(4-acryloyloxybutoxy)-benzoic acid or tri(methoxyethoxy) propylacyloxysilane, or a combination of at least two therefrom.

By specifically limiting the type of A group and B group in the structure of the refractive index modifier and the type of the refractive index modifier, the refractive index modifier can match with the entire organic-inorganic system, thereby better adjusting the refractive index of the system, reducing the light scattering of the system and improving the system transmittance.

The present disclosure further provides a method for preparing a zirconia monomeric dispersion liquid, comprising the following steps:

mixing the nano-zirconia with the monomeric resin for primary dispersion, and then mixing it with a stabilizer and a refractive index modifier for secondary dispersion to obtain a zirconia monomeric dispersion liquid.

In this preparation method, the nano-zirconia is mixed with the monomeric resin for primary dispersion, and then it is mixed with a stabilizer and a refractive index modifier for secondary dispersion. The preparation method has a simple process and does not require the participation of an intermediate phase in the entire dispersion process, which can greatly reduce the process steps and reduce the cost.

In some embodiments of the present disclosure, the time for primary dispersion is 30-90 min. A typical but non-limiting time for primary dispersion is 30 min, 40 min, 50 min, 60 min, 70 min, 80 min or 90 min.

In some embodiments of the present disclosure, the time for secondary dispersion is 30-60 min. Typical but non-limiting time for secondary dispersion is 30 min, 40 min, 50 min or 60 min.

In some embodiments of the present disclosure, both the primary dispersion and the secondary dispersion are performed using dispersing equipment.

The dispersing equipment described herein can be understood as any equipment or technical means in the field to disperse materials in the corresponding medium in the form of small droplets, including but not limited to mechanical stirring, magnetic stirring, ultrasonic, homogenizer, colloid mill, etc.

The present disclosure further provides an optical film, which is made by the above-mentioned zirconia monomeric dispersion liquid.

In view of the advantages of the above-mentioned zirconia monomeric dispersion liquid, the prepared optical film has good optical properties.

The present disclosure further provides a display screen, comprising the above-mentioned optical film.

In view of the advantages of the above-mentioned optical film, the display screen has good brightness and clarity.

The technical solutions provided by the present disclosure will be further described below in combination with examples and comparative examples.

### EXAMPLE 1

This example provided a zirconia monomeric dispersion liquid, including the following raw materials:

nano-zirconia, monomeric resin, stabilizer and refractive index modifier.

The average particle size of nano-zirconia was 10 nm, and the mass fraction of nano-zirconia in zirconia monomeric dispersion liquid was 50%, 60% and 75% respectively. The monomeric resin was phenoxybenzyl acrylate, and the stabilizer was polyoxyethylene octylphenol ether, with an addition amount being 5% of the mass of the nano-zirconia. The refractive index modifier was glycol ether, and its addition amount was 5% of the mass of the nano-zirconia.

The preparation method of the zirconia monomeric dispersion liquid provided in this example comprised the following steps:
dispersing nano-zirconia in monomeric resin with the aid of dispersing equipment, and continuously dispersing for 30 min to obtain monomeric pre-dispersion liquid; and then
adding a stabilizer and a refractive index modifier to the above-mentioned monomeric pre-dispersion liquid, and continuing the dispersion for 30 min to obtain a zirconia monomeric dispersion liquid.

### EXAMPLE 2-EXAMPLE 14

Example 2-Example 14 respectively provided a zirconia monomeric dispersion liquid, and the specific compositions are shown in Table 1.

The preparation method of the zirconia monomeric dispersion liquid provided in Example 2-Example 14 was the same as that in Example 1.

### Comparative Example 1-Comparative Example 7

Comparative Example 1-Comparative Example 7 respectively provided a zirconia monomeric dispersion liquid, and the specific compositions are shown in Table 1.

The preparation method of the zirconia monomeric dispersion liquid provided in Comparative Example 1-Comparative Example 7 was the same as that of Example 1.

It should be noted that the addition amount of stabilizer in Table 1 refers to the mass percentage of the stabilizer in nano-zirconia, the addition amount of the refractive index modifier refers to the mass percentage of the refractive index modifier in nano-zirconia, and the mass fraction of nano-zirconia refers to the mass fraction of nano-zirconia in the zirconia monomeric dispersion liquid.

At the same time, the transmittance at 650 nm wavelength of the zirconia monomeric dispersion liquid prepared in each example and comparative example was detected, and the transmittance was measured by a UV-visible spectrophotometer (C-7100 manufactured by Qingdao Lantesi Scientific and Educational Instrument Co., Ltd.). The specific results are shown in Table 1.

TABLE 1

| | | Addition | | Addition amount | | Mass | Transmittance of |
|---|---|---|---|---|---|---|---|
| Experiment | | amount | Refractive | of refractive | Monomeric | fraction of | monomeric |
| group | Stabilizer | of stabilizer | index modifier | index modifier | resin | nano-zirconia | dispersion liquid |
| Example 1 | polyoxyethylene | 5 wt % | glycol ether | 5 wt % | PBA | 50 wt % | 82% |
| | octylphenol ether | | | | | 60 wt % | 68% |
| | | | | | | 75 wt % | 57% |
| Example 2 | polyoxyethylene | 5 wt % | glycol ether | 5 wt % | BPMA | 50 wt % | 90% |
| | octylphenol ether | | | | | 60 wt % | 78% |
| | | | | | | 75 wt % | 65% |
| Example 3 | polyoxyethylene | 5 wt % | glycol ether | 5 wt % | BZA | 50 wt % | 74% |
| | octylphenol ether | | | | | 60 wt % | 62% |
| | | | | | | 75 wt % | 49% |
| Example 4 | polyoxyethylene | 5 wt % | glycol ether | 5 wt % | OPPEA | 50 wt % | 87% |
| | octylphenol ether | | | | | 60 wt % | 73% |
| | | | | | | 75 wt % | 58% |
| Example 5 | polyoxyethylene | 1 wt % | glycol ether | 1 wt % | PBA | 50 wt % | 62% |
| | octylphenol ether | | | | | 60 wt % | 49% |
| | | | | | | 75 wt % | 34% |
| Example 6 | polyoxyethylene | 10 wt % | glycol ether | 10 wt % | PBA | 50 wt % | 49% |
| | octylphenol ether | | | | | 60 wt % | 33% |
| | | | | | | 75 wt % | 20% |
| Example 7 | polyoxyethylene | 5 wt % | glycol ether | 5 wt % | PBA | 50 wt % | 80% |
| | alkyl ether | | | | | 60 wt % | 67% |
| | | | | | | 75 wt % | 54% |
| Example 8 | triethylhexyl | 5 wt % | glycol ether | 5 wt % | PBA | 50 wt % | 78% |
| | phosphoric acid | | | | | 60 wt % | 65% |
| | | | | | | 75 wt % | 51% |
| Example 9 | stearamide | 5 wt % | glycol ether | 5 wt % | PBA | 50 wt % | 81% |
| | | | | | | 60 wt % | 66% |
| | | | | | | 75 wt % | 52% |
| Example 10 | hydroxypropyl | 5 wt % | glycol ether | 5 wt % | PBA | 50 wt % | 83% |
| | acrylate | | | | | 60 wt % | 68% |
| | | | | | | 75 wt % | 54% |
| Example 11 | polyoxyethylene | 5 wt % | 4-(4-acryloyloxybutoxy)- | 5 wt % | PBA | 50 wt % | 85% |
| | octylphenol ether | | benzoic acid | | | 60 wt % | 72% |
| | | | | | | 75 wt % | 58% |
| Example 12 | polyoxyethylene | 5 wt % | tri(methoxyethoxy) | 5 wt % | PBA | 50 wt % | 83% |
| | octylphenol ether | | propylacyloxysilane | | | 60 wt % | 70% |
| | | | | | | 75 wt % | 59% |
| Example 13 | polyoxyethylene | 5 wt % | 4-(4-acryloyloxybutoxy)- | 5 wt % | OPPEA | 50 wt % | 88% |
| | octylphenol ether | | benzoic acid | | | 60 wt % | 75% |
| | | | | | | 75 wt % | 61% |
| Example 14 | polyoxyethylene | 5 wt % | tri(methoxyethoxy) | 5 wt % | BPMA | 50 wt % | 90% |
| | octylphenol ether | | propylacyloxysilane | | | 60 wt % | 76% |
| | | | | | | 75 wt % | 62% |
| Comparative | / | / | glycol ether | 5 wt % | PBA | 50 wt % | 18% |
| Example 1 | | | | | | 60 wt % | 14% |
| | | | | | | 75 wt % | 8% |
| Comparative | polyoxyethylene | 5 wt % | / | / | PBA | 50 wt % | 17% |
| Example 2 | octylphenol ether | | | | | 60 wt % | 12% |
| | | | | | | 75 wt % | 6% |
| Comparative | / | / | / | / | PBA | 50 wt % | 14% |
| Example 3 | | | | | | 60 wt % | 10% |
| | | | | | | 75 wt % | 4% |
| Comparative | / | / | / | / | BPMA | 50 wt % | 17% |
| Example 4 | | | | | | 60 wt % | 13% |
| | | | | | | 75 wt % | 8% |
| Comparative | polyoxyethylene | 15 wt % | glycol ether | 15 wt % | PBA | 50 wt % | 10% |
| Example 5 | octylphenol ether | | | | | 60 wt % | 5% |
| | | | | | | 75 wt % | 1% |
| Comparative | polyoxyethylene | 0.2 wt % | glycol ether | 5 wt % | PBA | 50 wt % | 18% |
| Example 6 | octylphenol ether | | | | | 60 wt % | 15% |
| | | | | | | 75 wt % | 9% |
| Comparative | polyoxyethylene | 5 wt % | glycol ether | 5 wt % | ethylhexyl | 50 wt % | 12% |
| Example 7 | octylphenol ether | | | | acrylate | 60 wt % | 6% |
| | | | | | (2-EHA) | 75 wt % | 1% |

From the data in Table 1, it can be seen that compared with Comparative

Examples 1-4, due to the addition of a stabilizer as well as a refractive index modifier in the Examples, both the dispersion effect and the adjustment effect of the refractive index of the zirconia monomeric dispersion liquid are better than those of Comparative Examples 1-4, so the transmittance of the monomeric dispersion liquid in the Examples are obviously higher than that of the Comparative Examples.

When the monomeric resin and nano-zirconia have a high matching degree of refractive index, it has a positive effect on improving the transmittance of the system. The refractive index matching degrees of nano-zirconia and monomeric resin PBA, BPMA, BZA and OPPEA in the present disclosure are higher than that of 2-EHA in Comparative Example 7. Therefore, the transmittance of the zirconia monomeric dispersion liquid prepared in Examples 1-4 is significantly higher than that in Comparative Example 7.

In the Example 5, the addition amount of stabilizer and the addition amount of the refractive index modifier are 1 wt %, which is lower than 5wt % in Example 1, its dispersion effect and refractive index adjustment effect are lower than those of Example 1. Therefore, in Example 5, transmittance of the monomeric dispersion liquid is lower than that in Example 1. In Example 6, the addition amount of stabilizer and refractive index modifier is 10 wt %, which is higher than 5wt % in Example 1, high content of stabilizer and refractive index modifier will affect the refractive index matching degree of each component of the whole system, and then affect the transmittance of the system, resulting in the transmittance of the monomeric dispersion liquid of Example 6 being lower than that of Example 1. As mentioned above, the amount of stabilizer and refractive index modifier should be controlled within a reasonable range, otherwise it will not only lead to the opposite effect, but also cause an increase in cost. Comparative Examples 5 and 6 can also illustrate this point.

Even though the present disclosure has been illustrated and described through particular examples, it should be noted that various other changes and modifications can be made without departing from the spirit and scope of the present disclosure. It is therefore intended to cover in the appended claims all such changes and modifications that are within the scope of the present disclosure.

### INDUSTRIAL APPLICABILITY

The zirconia monomeric dispersion liquid provided by the present disclosure is mainly made of raw materials such as nano-zirconia, monomeric resin, stabilizer and refractive index modifier. Among them, nano-zirconia is used as inorganic dispersed particles, which can reduce the scattering effect of particles on light, thereby improving the transmittance of the system; and the addition of stabilizers can improve the dispersion and uniformity of zirconia monomeric dispersion liquid. In addition, the addition of refractive index modifiers can make the refractive index of each raw material in the whole system match better, thus improving the transmittance of system. In view of the advantages of the zirconia monomeric dispersion liquid, the optical film that is prepared by it has good optical properties.

What is claimed is:

1. A zirconia monomeric dispersion liquid, wherein the zirconia monomeric dispersion liquid comprises following raw materials:
nano-zirconia, a monomeric resin, a stabilizer and a refractive index modifier, wherein
a mass fraction of the nano-zirconia accounting for the zirconia monomeric dispersion liquid is 50%-75%;
a mass of the stabilizer is 1%-10% of a mass of the nano-zirconia;
a mass of the refractive index modifier is 1%-10% of the mass of the nano-zirconia; and
the monomeric resin comprises any one of phenoxybenzyl acrylate, biphenylmethanol acrylate, benzyl acrylate or o-phenylphenoxyethyl acrylate, or a combination of at least two therefrom.

2. The zirconia monomeric dispersion liquid according to claim 1, wherein an average particle size of the nano-zirconia is 1-20nm.

3. The zirconia monomeric dispersion liquid according to claim 1, wherein a structure of the stabilizer is R—Xₙ, wherein
R is any one selected from alkyl groups, sulfonic acid groups, phosphate groups, amide groups, carboxyl groups, hydroxyl groups, aromatic rings or substituted aromatic rings, or a combination of at least two therefrom;
X is any one selected from polyether chains, acrylate chains, polyester chains or alkyl chains, or a combination of at least two therefrom; and
n is an integer between 1 and 3.

4. The zirconia monomeric dispersion liquid according to claim 3, wherein the stabilizer comprises any one of polyoxyethylene octylphenol ether, polyoxyethylene alkyl ether, triethylhexyl phosphoric acid, stearamide or hydroxypropyl acrylate, or a combination of at least two therefrom.

5. The zirconia monomeric dispersion liquid according to claim 1, wherein a structure of the refractive index modifier is A-Bₘ, wherein
A is any one selected from substituted or unsubstituted acryloyloxy groups, methylene groups, alkoxy groups, carbon-carbon double bonds, silyl groups or alkyl groups, or a combination of at least two therefrom;
B is any one selected from hydroxyl groups, carbonyl groups, ester groups, siloxy groups, alkoxy groups, carboxyl groups, or substituted or unsubstituted aromatic rings, or a combination of at least two therefrom; and
m is an integer between 1 and 3.

6. The zirconia monomeric dispersion liquid according to claim 5, wherein the refractive index modifier comprises any one of glycol ether, 4-(4-acryloyloxybutoxy)-benzoic acid or tri(methoxyethoxy) propylacyloxysilane, or a combination of at least two therefrom.

7. A preparation method of zirconia monomeric dispersion liquid, wherein the preparation method of zirconia monomeric dispersion liquid comprises following steps:
mixing nano-zirconia with a monomeric resin for a primary dispersion, and then mixing a resultant with a stabilizer and a refractive index modifier for a secondary dispersion to obtain the zirconia monomeric dispersion liquid.

8. The preparation method of zirconia monomeric dispersion liquid according to claim 7, wherein a time for the primary dispersion is 30-90 min.

9. The preparation method of zirconia monomeric dispersion liquid according to claim 7, wherein a time for the secondary dispersion is 30-60min.

10. The preparation method of zirconia monomeric dispersion liquid according to claim 7, wherein the primary dispersion and the secondary dispersion are all dispersed by a dispersing equipment.

11. An optical film, wherein the optical film is made of the zirconia monomeric dispersion liquid according to claim 1.

12. The preparation method of zirconia monomeric dispersion liquid according to claim 10, wherein the dispersing equipment is any equipment or technical means that is capable of dispersing materials in a corresponding medium in a form of small droplets.

13. The optical film according to claim 11, wherein an average particle size of the nano-zirconia in the zirconia monomeric dispersion liquid is 1-20 nm.

14. The optical film according to claim 11, wherein a structure of the stabilizer in the zirconia monomeric dispersion liquid is R-Xn, wherein
R is any one selected from alkyl groups, sulfonic acid groups, phosphate groups, amide groups, carboxyl groups, hydroxyl groups, aromatic rings or substituted aromatic rings, or a combination of at least two therefrom;
X is any one selected from polyether chains, acrylate chains, polyester chains or alkyl chains, or a combination of at least two therefrom; and
n is an integer between 1 and 3.

15. The optical film according to claim 11, wherein the refractive index modifier in the zirconia monomeric dispersion liquid comprises any one of glycol ether, 4-(4-acryloyloxybutoxy)-benzoic acid or tri(methoxyethoxy) propylacyloxysilane, or a combination of at least two therefrom.
